(19) United States
(12) Patent Application Publication
(10) Pub. No.: US 2024/0354411 A1
(43) Pub. Date: Oct. 24, 2024

(54) RAPID RANSOMWARE DETECTION AND RECOVERY

(71) Applicant: VMware, Inc., Palo Alto, CA (US)

(72) Inventors: Zhe WANG, Cupertino, CA (US); Wenguang WANG, Santa Clara, CA (US); Enning XIANG, San Jose, CA (US); Jianhan ZHAN, Shanghai (CN); Rajesh JOSEPH, Bengaluru (IN); Bing JIAO, Tallahassee, FL (US)

(21) Appl. No.: 18/335,130

(22) Filed: Jun. 15, 2023

(30) Foreign Application Priority Data
Apr. 21, 2023 (WO) PCT/CN2023/089739

(51) Int. Cl. G06F 21/56; G06F 9/455; G06F 21/55

(52) U.S. Cl. CPC G06F 21/566; G06F 9/45558; G06F 21/554; G06F 2009/45587; G06F 2221/034

(57) ABSTRACT

Solutions for rapid ransomware detection and recovery include: receiving a first set of in-memory changed data blocks; identifying, within the first set of in-memory changed data blocks, a second set of in-memory changed data blocks addressed for storage within a file index for a virtual machine (VM) disk; determining, relative to a change history of the file index, an anomalous condition; based on at least determining the anomalous condition, identifying a third set of blocks within the file index that are changed between two versions of the VM disk; determining that changes in the third set of blocks indicate ransomware; and based on at least determining that changes in the third set of blocks indicate ransomware, generating an alert. Machine learning (ML) models may perform anomaly/ransomware detection. Remediation activities may include disk restoration storing the VM memory.

### BACKGROUND

Damage caused by ransomware has been growing significantly, due to multiple factors: the use of cryptocurrency makes tracking attackers difficult, the focus on enterprise customers provides significant economic motivation for investment in capability, and a ransomware-as-a-service model enables specialization that permits developers to concentrate on capability growth while others scale out infiltration and operations.

Traditional ransomware defense focuses on prevention, using an approach similar to anti-virus/malware protection, which often includes signature-based detection. However, although such a defense is useful, it is not always successful, due to the use of zero-day exploits in some ransomware attacks. File system scanning tools, which may be acceptable on single-user systems, are prohibitively expensive for large virtual machine (VM) deployments, where the number of concurrently-executing VMs may number in the thousands or more.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Aspects of the disclosure provide solutions for rapid ransomware detection and recovery. Examples include: receiving a first set of in-memory changed data blocks; identifying, within the first set of in-memory changed data blocks, a second set of in-memory changed data blocks addressed for storage within a file index for a virtual machine (VM) disk; determining, relative to a change history of the file index, an anomalous condition; based on at least determining the anomalous condition, identifying a third set of blocks within the file index that are changed between two versions of the VM disk; determining that changes in the third set of blocks indicate ransomware; and based on at least determining that changes in the third set of blocks indicate ransomware, generating an alert. Machine learning (ML) models may perform anomaly/ransomware detection. Remediation activities may include disk restoration storing the VM memory.

Additional examples include: receiving a first set of in-memory changed data blocks; identifying, within the first set of in-memory changed data blocks, a second set of in-memory changed data blocks addressed for storage within a file index for a VM disk; determining, relative to a change history of the file index, an anomalous condition; and based on at least determining the anomalous condition, generating an alert.

Additional examples also include: based on at least determining an anomalous condition for a file back-up operation or file save operation of a first VM disk, loading at least a portion of a second VM disk from persistent storage; identifying a set of blocks within a file index that are changed between the first VM disk and the second VM disk; determining that changes in the set of blocks indicate ransomware; and based on at least determining that changes in the set of blocks indicate ransomware, generating an alert.

### BRIEF DESCRIPTION OF THE DRAWINGS

The present description will be better understood from the following detailed description read in the light of the accompanying drawings, wherein:

FIG. 1 illustrates an example architecture that advantageously provides for rapid ransomware detection and recovery;

FIG. 2 illustrates an example virtualization architecture that may be used in an example architecture such as that of FIG. 1;

FIG. 3 illustrates a training environment for machine learning (ML) models that implement a two-phase approach to ransomware detection, as used in an example architecture such as that of FIG. 1;

FIGS. 4A and 4B illustrate further detail for aspects of a VM disk, as used in an example architecture such as that of FIG. 1;

FIG. 5 illustrates a notional comparison of two versions of a VM disk, as used in an example architecture such as that of FIG. 1;

FIGS. 6 and 7 illustrate flowcharts of exemplary operations associated with an example architecture, such as that of FIG. 1;

FIG. 8A illustrates adaption of aspects of the architecture of FIG. 1 to cloud disaster recovery;

FIG. 8B illustrates adaption of aspects of the architecture of FIG. 1 to a virtual storage area network;

FIG. 8C illustrates adaption of aspects of the architecture of FIG. 1 to a cloud-based virtualization platform;

FIGS. 9-12 illustrate additional flowcharts of exemplary operations associated with an example architecture, such as that of FIG. 1; and

FIG. 13 illustrates a block diagram of an example computing apparatus that may be used as a component of an example architecture such as that of FIG. 1.

Any of the figures may be combined into a single example or embodiment.

### DETAILED DESCRIPTION

In large virtual machine (VM) deployments, typical approaches for ransomware detection are prohibitively expensive or otherwise impractical from a technical perspective. Aspects of the disclosure improve the security of computing operations by rapidly detecting and enabling recovery from ransomware. This is accomplished, at least in part, by identifying a set of in-memory changed data blocks addressed for storage within a file index for a VM disk, and determining an anomalous condition. Upon determining the anomalous condition, changes between two versions of the VM disk are identified. If the changes indicate ransomware, remediation efforts are triggered. In some examples, machine learning (ML) models perform the anomaly/ransomware detection. Further, example remediation activities include restoration of a disk storing the VM memory.

The multi-phase approach as described herein leverages incremental file storage and snapshots, which store only changes to the VM disk between baseline snapshots, to minimize the amount of data being analyzed. Further processing speed enhancement is achieved because in-memory data is intercepted, rather than being read from persistent storage until necessary to do so, and the data to be analyzed is further limited (at least initially) to changed blocks within the VM disk's file index. In some examples, the VM disk file index is the common new technology file system (NTFS) master file table (MFT), with a well-known format and content that may be leveraged for the techniques described herein.

Even a large VM disk, on the order of a terabyte (TB), may be rapidly checked for a possible ransomware attack quickly, because the file index may be on the order of a gigabyte (GB), and the changed blocks are in the range of kilobytes (KB). An initial phase checks changed blocks that are already in memory, and false alarms are reduced by checking changed blocks in prior-saved versions of the VM disk. A scan of the entire TB-sized VM disk is avoided, providing significant speed improvement and a reduction in use of computing resources such as memory and processing. Thus, aspects of the disclosure provide a practical, useful result to solve a technical problem in the domain of computing.

Some examples include receiving a first set of in-memory changed data blocks. A second set of in-memory changed data blocks, addressed for storage within a file index for a virtual machine (VM) disk, are identifying within the first set of in-memory changed data blocks. An anomalous condition is determined relative to a change history of the file index. Based on at least determining the anomalous condition, a third set of blocks is identified. The third set of blocks are within the file index that are changed between two versions of the VM disk. Based on at least determining that changes in the third set of blocks indicate ransomware, an alert is generated.

Additional examples include receiving a first set of in-memory changed data blocks. A second set of in-memory changed data blocks addressed for storage within a file index for a VM disk are identified within the first set of in-memory changed data blocks. An anomalous condition is determined relative to a change history of the file index. Based on at least determining the anomalous condition, an alert is generated.

Additional examples also include loading at least a portion of a second VM disk from persistent storage, based on at least determining an anomalous condition for a file back-up operation or file save operation of a first VM disk. A set of blocks within a file index that are changed between the first VM disk and the second VM disk are identified. Based on at least determining that changes in the set of blocks indicate ransomware, an alert is generated.

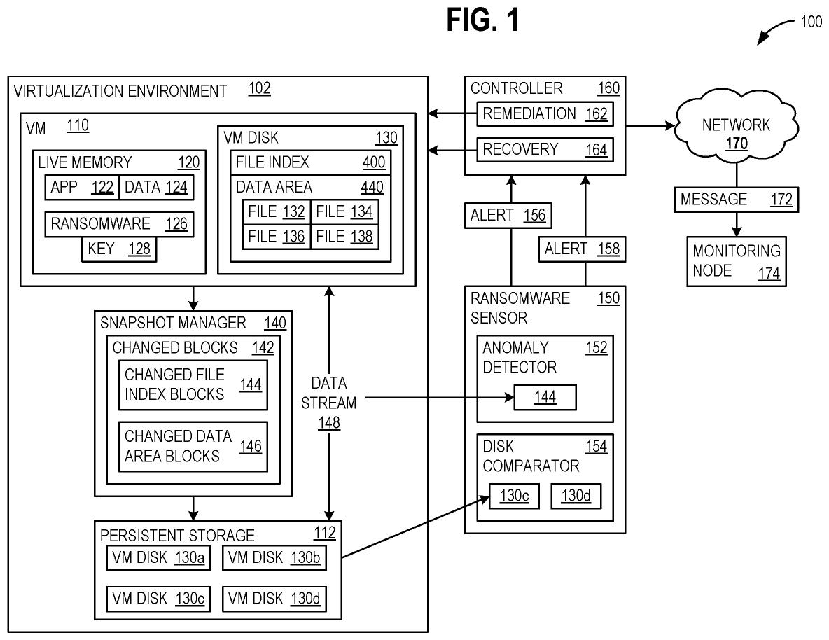

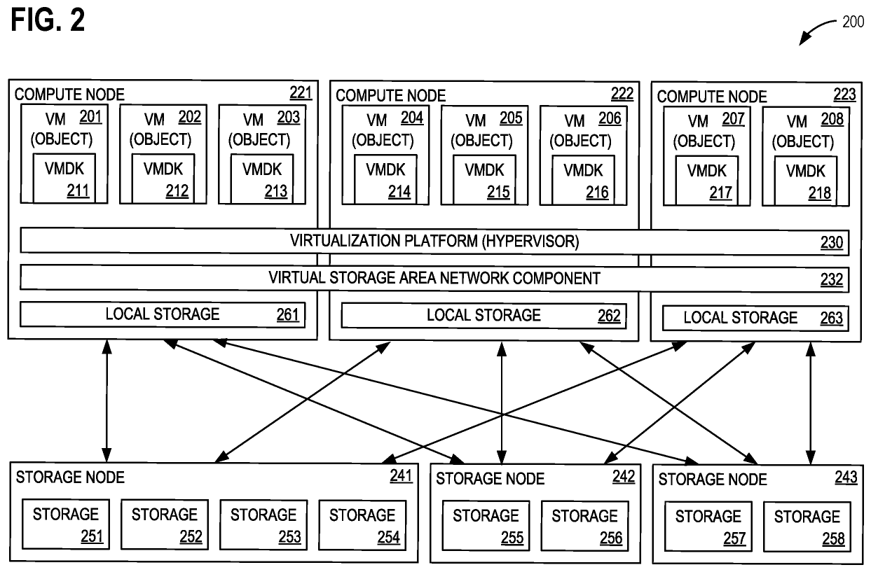

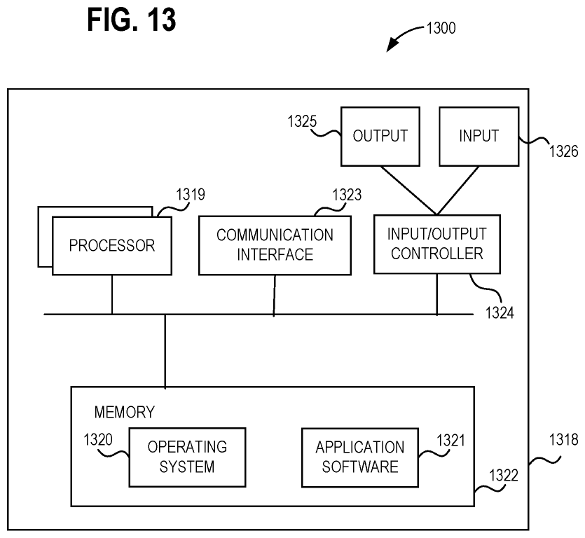

FIG. 1 illustrates an example architecture 100 that advantageously provides for rapid ransomware detection and recovery. Components of architecture 100, for example a virtualization environment 102, a ransomware sensor 150, a controller 160, and a monitoring node 174 may be implemented on one or more computing apparatus 1318 of FIG. 13, and/or using a virtualization architecture 200 as is illustrated in FIG. 2.

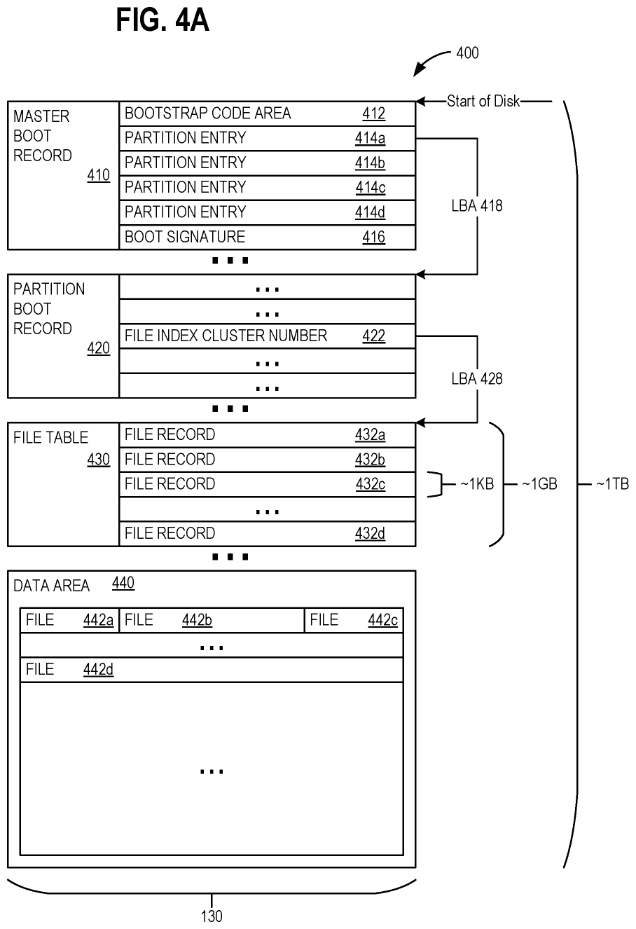

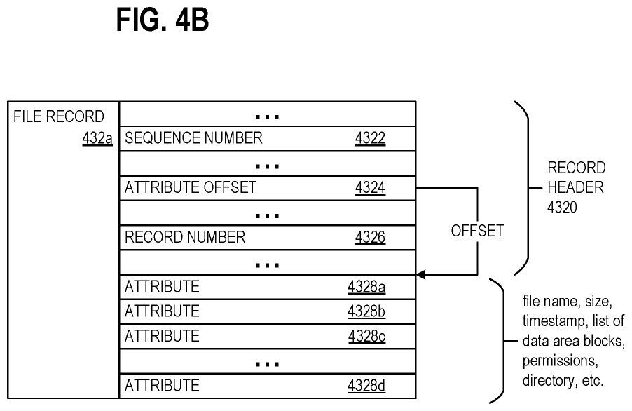

Virtualization environment 102 hosts a VM 110, and may host additional VMs numbering in the thousands or more. VM 110 has live memory 120 and a VM disk 130 that is a virtualized version of a persistent storage disk used for a typical computing apparatus. In some examples, VM disk 130 uses the NTFS format, which is shown in further detail in FIGS. 4A and 4B. VM disk 130 has a file index 400 that provides indexing information for files 132-138 on VM disk 130, stored within a data area 440. VM 110 executes at least one application, shown as app 122 that operates on and/or produces data 124, in order to provide value to users. Some or all of data 124 may be stored, or intended for storage, in one or more of files 132-138.

In the scenario described herein, VM 110 is the subject of a successful ransomware attack, and ransomware 126 is in live memory 120, using an encryption key 128 to encrypt files stored in VM 110, such as one or more of files 132-136. For example, at some point in time at which VM 110 is in the process of being backed up, ransomware 126 has already encrypted file 132 and file 134, but has not yet had time to encrypt file 136 or file 138. This attack may render some or all of data 124 unavailable to the user.

An image of VM disk 130 is backed up on a schedule (e.g., hourly) and/or a milestone basis by a snapshot manager 140 that generates snapshots for storage in a persistent storage 112, such as a magnetic storage medium. Four stored versions of VM disk 130 are shown, VM disks 130a-130d, in this example. In some examples, VM disks 130a-130d are stored as VMDKs, as described in further detail in relation to FIG. 2. In some examples, snapshots are deleted after an expiration period, in order to preserve storage space. An expiration event may require a storing of a new full VM disk baseline. The snapshots provide recovery points in the event of a system crash, virus infection, or (in this case) ransomware attack.

Snapshot manager 140 performs incremental back-ups. For example, a complete copy of VM disk 130 may have been stored as a baseline snapshot as VM disk 130a, and changes to VM disk 130 that had accumulated by the time snapshot manager 140 performed the next snapshot were stored as VM disk 130a. Changes that then accumulated after the storage of VM disk 130a were saved as VM disk 130b, and changes that accumulated after the storage of VM disk 130b were saved as VM disk 130c. At the current point in time illustrated in FIG. 1, the changes that accumulated after the storage of VM disk 130c are being saved as VM disk 130d.

The changes are in the resolution of blocks, which, in some examples, are 4 KB. Snapshot manager 140 identifies the changed portions of VM disk 130 (since the immediately prior saved snapshots) in block-sized chunks, while they are still in live memory of virtualization environment 102. Live memory 120 of VM 10 may be saved at a later time, as described below. These changes are extracted as in-memory changed data blocks 142. Some of in-memory changed data blocks 142 are from file index 400 of VM disk 130, and are shown as changed file index blocks 144, whereas others of in-memory changed data blocks 142 are from data area 440 of VM disk 130, and are shown as changed data area blocks 146. In some examples, logical block addresses (LBAs) of in-memory changed data blocks 142 are used to distinguish between blocks that are from file index 400 versus data area 440. This is possible because LBAs for file index 400 and data area 440 in VM disk 130 will be distinct.

When any of files 132-138 change, such as by the file growing in size, shrinking, having content altered, and/or the file name or path changing, the indexing information within file index 400 changes. File content changes are reflected in data area 440, and are captured in changed data area blocks, whereas file attribute changes are captured in changed file index blocks. Some file attributes may or may not change, such as file name, file extension, size, directory (path), whereas some attribute information will change, such as timestamp and log sequence number (LSN). A log sequence number is an ever-increasing count of file index changes. Any newly changed file will have an LSN that is larger than the prior maximum LSN. Additionally, it is possible to determine whether a file has changed by comparing its current timestamp with its timestamp in a prior snapshot.

In-memory changed data blocks 142 may be regarded as streaming data, in a data stream 148. Ransomware sensor 150 intercepts in-memory changed data blocks 142 in a data stream 148, for example, by a push or pull operation, and performs a multi-phase ransomware detection operation to detect the presence (or absence) of ransomware 126. Ransomware sensor 150 has an anomaly detector 152 that operates on changed file index blocks 144, as described in further detail below. If anomaly detector 152 detects an anomalous condition that may be the result of a ransomware attack, anomaly detector 152 generates an alert 156 that triggers further examination by a disk comparator 154 and at least some remediation activity by controller 160.

In some examples, two scenarios exist for in-memory changed data blocks 142. A snapshot ingestion process obtains a list of changed blocks that is different from the current snapshot, by comparing with the previous snapshot. The changed disk blocks were read, as some point, from persistent storage 112, but not in support of this ransomware detection. That is, in-memory changed data blocks 142 are already in live memory 120 from a prior read event, and ransomware sensor 150 opportunistically examines in-memory changed data blocks 142 without requiring a further read from persistent storage 112.

Another scenario is for data writing, in which ransomware detection is injected into the write path, in such a way that when the host OS is writing new data to the external storage (persistent storage 112) ransomware sensor 150 is able to see in-memory changed data blocks 142 within data stream 148 as it is being written for the first time to persistent storage. In this scenario, in-memory changed data blocks 142 have not been read from persistent storage 112.

Disk comparator 154 reads in one or more versions of VM disk 130 to perform a more in-depth assessment of the presence or absence of ransomware that has a lower false alarm rate. That is, anomaly detector 152 has high sensitivity to avoid missing a detection, and disk comparator 154 has a low probability of false alarm, in order to minimize unnecessary, potentially disruptive remediation and recovery activities.

If disk comparator 154 detects ransomware 126, disk comparator 154 generates an alert 158 that triggers remediation activity, and possibly recovery activity, by controller 160. Controller 160 has remediation logic 162 that performs remediation activity, such as transmitting a message 172 to monitoring node 174 across a computer network 170, suspending the expiration of older snapshots (e.g., VM disk 130a), storing a copy of live memory 120, storing the state of VM 110, and sandboxing VM 110 to prevent infection of other VMs in virtualization environment 102. In some examples, controller 160 also has restoration logic 164 that restores VM disk 130 from a prior snapshot that is free of ransomware 126 and does not have encrypted files.

By storing a copy of live memory 120, it may be possible to capture a copy of ransomware 126 and encryption key 128, which may have value for forensics, remediation, and/or recovery efforts. It may also assist with preventing future attacks by ransomware 126, by permitting a signature-based prevention measure to recognize and neutralize ransomware 126. The prospect of capturing a copy of ransomware 126 may also serve as a deterrent to an attacker attempting to insert ransomware 126 into an environment that uses aspects of the disclosure.

Ransomware sensor 150 and controller 160 may each be co-located with VM 110, or located across a computer network 170. If the rapid ransomware detection disclosed herein is used as a ransomware-detection-as-a-service (RDaaS), ransomware sensor 150 and controller 160 may be located on a central node in order to service multiple virtualization environments. This arrangement enables learning of a ransomware attack in one virtualization environment to benefit detection efforts in the others.

Examples of architecture 100 are operable with virtualized and non-virtualized storage solutions. FIG. 2 illustrates a virtualization architecture 200 that may be used as a component of architecture 100. Virtualization architecture 200 is comprised of a set of compute nodes 221-223, interconnected with each other and a set of storage nodes 241-243 according to an embodiment. In other examples, a different number of compute nodes and storage nodes may be used. Each compute node hosts multiple objects, which may be virtual machines, containers, applications, or any compute entity (e.g., computing instance or virtualized computing instance) that consumes storage. A virtual machine includes, but is not limited to, a base object, linked clone, independent clone, and the like. A compute entity includes, but is not limited to, a computing instance, a virtualized computing instance, and the like.

When objects are created, they may be designated as global or local, and the designation is stored in an attribute. For example, compute node 221 hosts objects 201, 202, and 203; compute node 222 hosts objects 204, 205, and 206; and compute node 223 hosts objects 207 and 208. Some of objects 201-208 may be local objects. In some examples, a single compute node may host 50, 100, or a different number of objects. Each object uses a VM disk (VMDK), for example VMDKs 211-218 for each of objects 201-208, respectively. Other implementations using different formats are also possible. A virtualization platform 230, which includes hypervisor functionality at one or more of compute nodes 221, 222, and 223, manages objects 201-208. In some examples, various components of virtualization architecture 200, for example compute nodes 221, 222, and 223, and storage nodes 241, 242, and 243 are implemented using one or more computing apparatus such as computing apparatus 1318 of FIG. 13.

Virtualization software that provides software-defined storage (SDS), by pooling storage nodes across a cluster, creates a distributed, shared data store, for example a storage area network (SAN). Thus, objects 201-208 may be virtual SAN (vSAN) objects. In some distributed arrangements, servers are distinguished as compute nodes (e.g., compute nodes 221, 222, and 223) and storage nodes (e.g., storage nodes 241, 242, and 243). Although a storage node may attach a large number of storage devices (e.g., flash, solid state drives (SSDs), non-volatile memory express (NVMe), Persistent Memory (PMEM), quad-level cell (QLC)) processing power may be limited beyond the ability to handle input/output (I/O) traffic. Storage nodes 241-243 each include multiple physical storage components, which may include flash, SSD, NVMe, PMEM, and QLC storage solutions. For example, storage node 241 has storage 251, 252, 253, and 254; storage node 242 has storage 255 and 256; and storage node 243 has storage 257 and 258. In some examples, a single storage node may include a different number of physical storage components.

In the described examples, storage nodes 241-243 are treated as a SAN with a single global object, enabling any of objects 201-208 to write to and read from any of storage nodes 251-258 using a virtual SAN component 232. Virtual SAN component 232 executes in compute nodes 221-223. Using the disclosure, compute nodes 221-223 are able to operate with a wide range of storage options. In some examples, compute nodes 221-223 each include a manifestation of virtualization platform 230 and virtual SAN component 232. Virtualization platform 230 manages the generating, operations, and clean-up of objects 201 and 202. Virtual SAN component 232 permits objects 201 and 202 to write incoming data from object 201 and incoming data from object 202 to storage nodes 241, 242, and/or 243, in part, by virtualizing the physical storage components of the storage nodes.

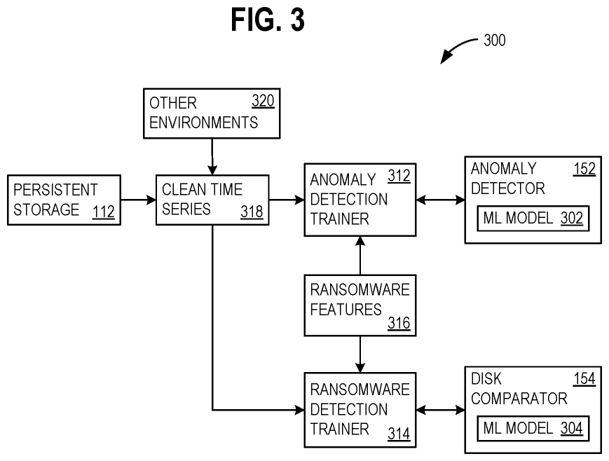

FIG. 3 illustrates a training environment 300 for ML models 302 and 304 that perform the detection of an anomalous condition and ransomware 126, in some examples. An anomaly detection trainer 312 trains ML model 302 in anomaly detector 152, and a ransomware detection trainer 314 trains ML model 304 in disk comparator 154. ML models 302 and 304 are trained to recognize signs of ransomware, based on comparing typical behavior for VM disk 130 (or, in some examples, a generic VM disk) against ransomware behavior from a database of ransomware features 316.

Some ransomware behavior, which is observable in changes to file index 400, includes increasing file name entropy by using machine-generated file names, adding file extensions such as “crypt” or “locked”, increasing file counts in directories when adding a ransom note, and increasing file size by including metadata and/or session keys with the encrypted version of a file. For example, if there is suddenly a large number of different file extensions that are all unknown, or a common new file extension that is unknown (i.e., not correlated with a known software application), these file extensions may be correlated with ransomware.

Some ransomware uses a public key pair and session keys. A session key is generated to encrypt the file with a symmetric algorithm, such as AES, and the session key is encrypted with the public key of the pair (e.g., encryption key 128). The encrypted session key and other ransom-related data is appended to the encrypted file, and the private key is not made available until the ransom is paid.

Because the goal of the ransomware attacker is often to disrupt the user's data as much as possible, ransomware 126 is likely to attempt to encrypt as many files as quickly as possible, prior to detection and interruption. As a result, the count of changed files and a count of directories having an additional file, that are included in an incremental snapshot (or other save) operation, is likely to be higher than is typically the case for typical VM activity absent ransomware. High entropy data blocks may be mapped to file index 400, which enables deriving a count of likely-encrypted files.

The above changes are observable within changed file index blocks 144, even using only the changed blocks within live memory, which is a subset of in-memory changed data blocks 142. These can be seen by anomaly detector 152. This same behavior can be examined in further detail by disk comparator 154 when loading a prior-saved version of VM disk 130 and comparing file index 400 between two versions of VM disk 130 to determine changed blocks between the two versions. That is, it is possible to identify encrypted files by mapping changed area data blocks 146 having high entropy to specific files (e.g., of files 132-138) using the file index 400.

However, in some examples, disk comparator 154 also looks at blocks within data area 440 of VM disk 130 that are changed between two versions, and/or the changes from the in-memory version of VM disk 130 (e.g., changed data area blocks 146). If the files are encrypted, the content of the files will have higher entropy, which is observable in the changed blocks. Each of these indicators adds to a score that is used to determine whether ransomware is present or has been present on VM 110.

In some examples, a clean VM, for example VM 110 prior to the insertion of ransomware 126, running for some period of time produces a baseline of operational history that is stored in persistent storage 112. This history is parsed to produce a clean time series 318 of changes to file index 400. In some examples, clean operation history from other virtualization environments 320 (e.g., from an RDaaS deployment) are pooled to generate a larger time series 318. In some examples, time series 318 spans 30 days or more, in order to capture repeating, periodic activities, such as weekly updates, in order to ascertain “normal” behavior in the absence of ransomware.

FIG. 4A illustrates further detail for file index 400 and data area 440. In the illustrated example, the entirety of VM disk 130 is sized on the order of 1 TB, and file index 400 starts at the beginning of VM disk 130. File index 400 has a master boot record 410 with a bootstrap code area 412; partition entries including a partition entry 414a, a partition entry 414b, a partition entry 414c, a partition entry 414d; and a boot signature 416. Partition entry 414a holds an LBA 418 for a partition boot record 420, which includes a file index cluster number 422. File index cluster number 422 hold an LBA 428 for a file table 430, which is an NTFS MFT, in some examples.

File table 430 has a size on the order of 1 GB and has file records, sized on the order of 1 KB (e.g., 1024 bytes each), that each points to a file in data area 440, in an example. In the illustrated example, a file record 432a points to file 442a, a file record 432b points to file 442b, a file record 432c points to file 442c, and a file record 432d points to file 442d. Files 442a-442d are representations of files 432-438 when allocated to disk clusters. Each of files 442a-442d has its own file record. Whenever any of files 442a-442d is changed, its corresponding file record is updated. Although files 442a-442d are shown as contiguous, they may instead be fragmented.

With 1 KB file records and 4 KB blocks, each block holds four file records. Any one of those four records changing means that the entire block is a changed block. In some examples, the storage system determines the block size, and changes are written using 64 KB blocks.

FIG. 4B illustrates further detail for file records, with file record 432a shown as an example. File record 432a has metadata information about files and directories, such as file name, file size, timestamp for file creation/modification/last access, disk location of the file data, LBA (location on disk), directory (path) information, and more. For example, file record 432a has a sequence number 4322, an attribute offset 4324, and a record number 4326. A record header 4320 comprises sequence number 4322, attribute offset 4324, and record number 4326 (e.g., a 64-bit LSN). Attribute offset 4324 points to attributes 4328a-4328d that start after record header 4320.

For example, attribute 4328a may be the file name (with the file extension), attribute 4328b may be the file size, attribute 4328c may be a timestamp, and attribute 4328d may be an LBA. Other attributes include permissions, and other arrangements of the metadata are possible.

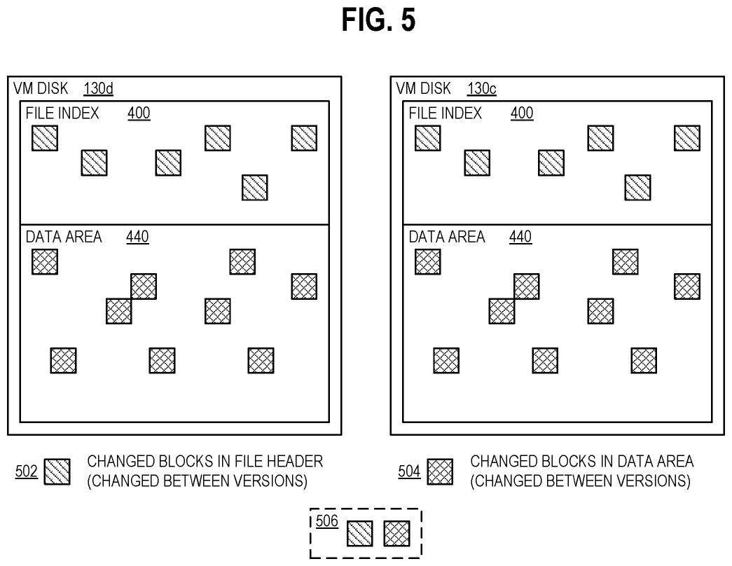

FIG. 5 illustrates a notional comparison of two versions of VM disk 130, shown as VM disk 130d and the prior version, VM disk 130c. Whereas it is likely that VM disk 130c was loaded from persistent storage 112, VM disk 130d may have been read from persistent storage 112, or may instead be captured from in-memory data. The notional illustration of FIG. 5 shows VM disk 130c and 130d as a reconstituted VM disk. Since architecture 100 uses incremental file save and snapshot operations, VM disks 130c and 130d, as saved to persistent storage 112, will not have the entirety of the contents of VM disk 130. In some examples, it is not necessary to reconstitute VM disk 130 to determine which blocks are changed in VM disks 130c and 130d.

As illustrated, changed blocks 502 are blocks that are changed between versions of VM disk 130, and are within file index 400, while changed blocks 504 are blocks that are changed between versions of VM disk 130, and are within data area 440. Changed blocks 502 are used by disk comparator 154 to detect ransomware 126, although some examples also look at entropy within changed blocks 504. Together changed blocks 502 and changed blocks 504 form a set of blocks 506 that are changed between two versions of VM disk 130.

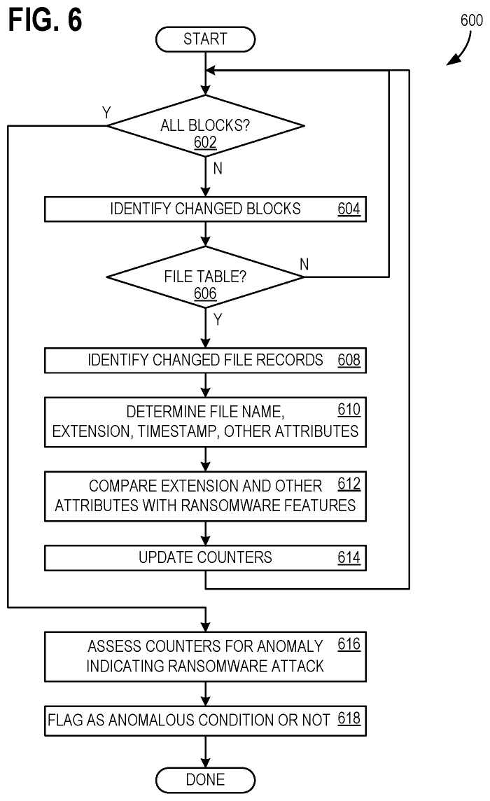

FIG. 6 illustrates a flowchart 600 of exemplary operations that may be performed by examples of anomaly detector 152. Flowchart 600 shows an algorithmic approach, rather than an ML-based approach, in which counters are used in a voting or fuzzy logic approach to declaring the existence of an anomalous condition. In some examples, the operations of flowchart 600 are performed by one or more computing apparatus 1318 of FIG. 13. Flowchart 600 commences with a decision operation 602 that determines whether all blocks or sectors or VM disk 130 have been assessed. If not, operation 604 identifies changed blocks that will be included within in-memory changed data blocks 142. Decision operation 606 determines whether the changed blocks are also within file index 400, specifically within file table 430 and thus within changed file index blocks 144. If not, flowchart 600 returns to decision operation 602. If the changed blocks are within changed file index blocks 144, operation 608 identifies changed file records (e.g., file record 432a).

Operation 610 determines file names, file extensions, creation timestamps, and other attributes for the changed files. At this stage, anomaly detector 152 does not have access to what the attribute had been changed from (e.g., the prior file size), because anomaly detector 152 can only see current values. Disk comparator 154 will have visibility into what the file attribute had been changed from, in the next phase (if triggered), for example determining whether a file size has increased.

Operation 612 compares the attributes, such as 4328a-4328b, with ransomware features, and matches with ransomware features result in updating (e.g., incrementing) a set of counters, for example feature-specific counters, in operation 614. Flowchart 600 then returns to decision operation 602.

When all blocks are accounted for, flowchart 600 moves to operation 616, in which anomaly detector 152 assess the counters for some threshold to declare an anomalous condition. Operation 618 sets the proper flag for an anomalous condition or an absence of an anomalous condition.

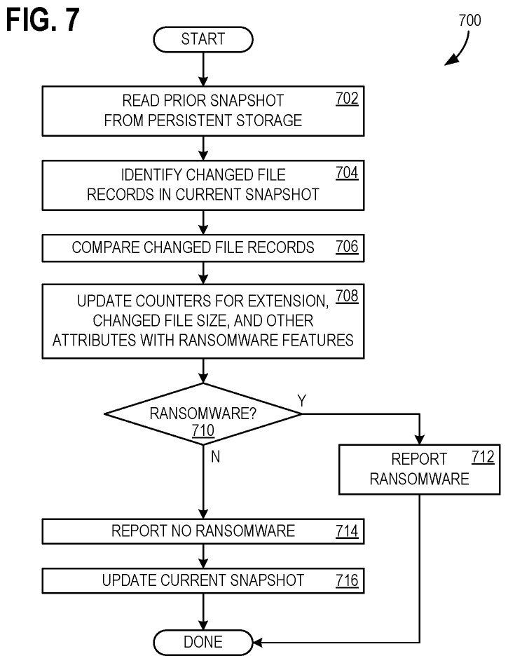

FIG. 7 illustrates a flowchart 700 of exemplary operations that may be performed by examples of disk comparator 154. Similarly to flowchart 600, flowchart 700 shows an algorithmic approach, rather than an ML-based approach, in which counters are used in a voting or fuzzy logic approach to declaring the existence of a ransomware attack. In some examples, the operations of flowchart 700 are performed by one or more computing apparatus 1318 of FIG. 13.

Flowchart 700 commences with disk comparator 154 reading the prior snapshot (e.g., VM disk 130c) from persistent storage in operation 702. Operation 704 identifies at least changed blocks 502, which are within file index 400. Versions of disk comparator 154 that also examine entropy of file contents also identify changed blocks 504. This permits disk comparator 154 to identify changed file records, which are compared in operation 706. In some examples, operation 706 also compares changes to file content entropy.

Operation 708 increments counters when file attributes or changes to file attributes match ransomware features. The set of counters may be similar to the set of counters used in operation 614 of FIG. 6. Decision operation 710 determines whether the counter values are sufficiently high to flag a ransomware attack in operation 712. If not, disk comparator 154 reports that no ransomware attack is apparent in operation 714, and the save operation of the current snapshot proceeds in operation 716.

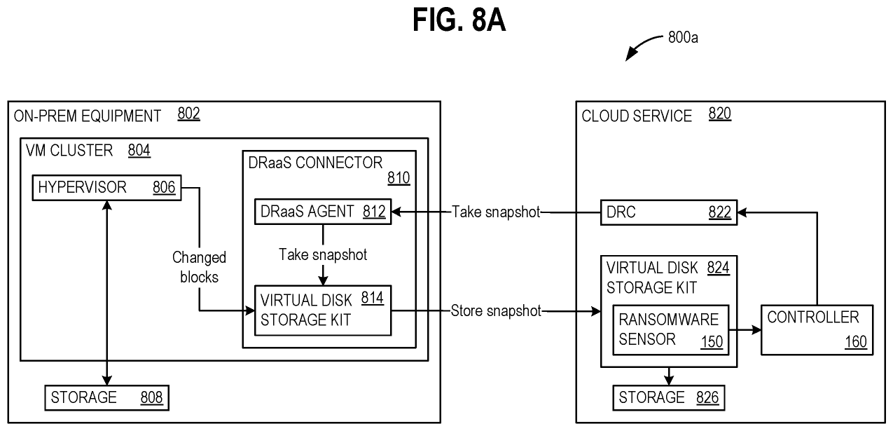

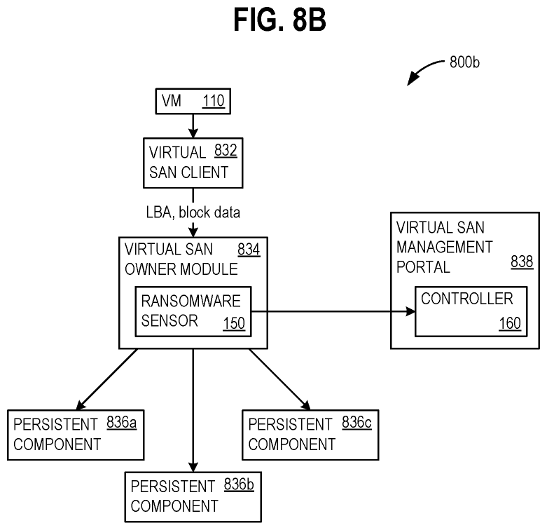

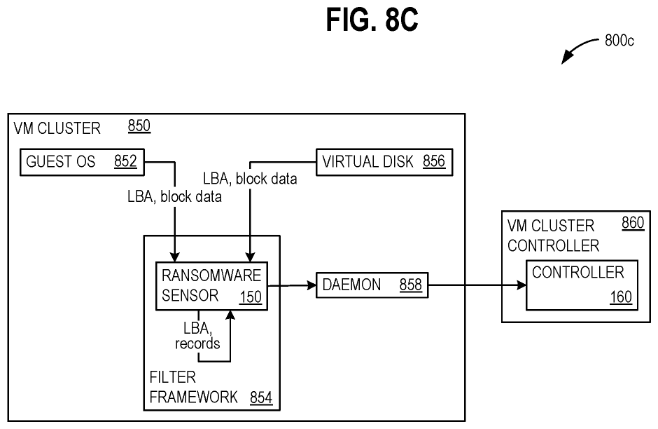

FIG. 8A illustrates adaption of architecture 100 to a cloud disaster recovery architecture 800a, which provides RDaaS as part of disaster recovery as a service (DRaaS). On-prem equipment 802 has a VM cluster 804 deployment, which has a hypervisor 806 that may be similar to hypervisor 230 of FIG. 2, and has local storage 808 supporting the VMs in VM cluster 804. A DRaaS connector 810 has a DRaaS agent 812 and a virtual disk storage kit 814 that facilitates accessing and managing virtual disks, such as VM disk 130.

A cloud service 820 has a disaster recovery controller (DRC) 822, a virtual disk storage kit 824, and back-up storage 826 that is located remotely from VM cluster 804 in order to facilitate recovery from disasters affecting on-prem equipment 802.

In order to add RDaaS to DRaaS, cloud service 820 has ransomware sensor 150 and a version of controller 160. DRC 822 instructs DRaaS agent 812 to take a snapshot, which may be in the normal course of disaster preparedness. DRaaS agent 812 instructs virtual disk storage kit 814 to take a snapshot. Virtual disk storage kit 814 obtains changed blocks from hypervisor 806, which initially are in-memory changed data blocks 142. Changed blocks 502 and 504 may be obtained later, if needed for the second phase of ransomware detection.

Virtual disk storage kit 814 forwards the changed blocks for snapshot storage to virtual disk storage kit 824. Virtual disk storage kit 824 has ransomware sensor 150 that performs the ransomware detection as described elsewhere herein. If ransomware is detected (e.g., ransomware 126 of FIG. 1), ransomware sensor 150 alerts controller 160, which triggers DRC 822 to perform remediation and recovery operations, for example using DRaaS connector 810. Otherwise, if the changed blocks are free from ransomware, they are stored in the current snapshot for potential use in a later disaster recovery.

FIG. 8B illustrates adaption of architecture 100 to a virtual storage area network (virtual SAN) architecture 800b. Ransomware sensor 150 is located within a virtual SAN owner module 834, in the path between VM 110 and persistent components 836a-836c. Persistent component 836a, persistent component 836b, and persistent component 836c are versions or equivalents of persistent storage 112. A virtual SAN client 832 extracts LBA and block data from the data stream between VM 110 and persistent components 836a-836c, which may be similar to data stream 148.

Ransomware sensor 150 is able to perform anomaly detection asynchronously, without introducing extra I/O latency. In some expected scenarios, ransomware may be attacking only a few SAN objects at the same time, so the performance impact of loading prior-saved blocks is relatively small. When a ransomware attack is detected, controller 160 inside a virtual SAN management portal 838 is alerted by leveraging existing SAN architecture assets.

FIG. 8C illustrates adaption of architecture 100 to a cloud-based virtualization architecture 800c. Within a VM cluster 850, a filter framework 854 holds ransomware sensor 150 and receives LBA and block data from a guest operating system (OS) 852 of a VM and also from a virtual disk 856, which may be a version of VM disk 130. Ransomware sensor 150 detects ransomware, as described herein, and alerts are forwarded to controller 160 within a VM cluster controller 860, using a daemon 858, which is running as a background process for forwarding alerts from ransomware sensor 150.

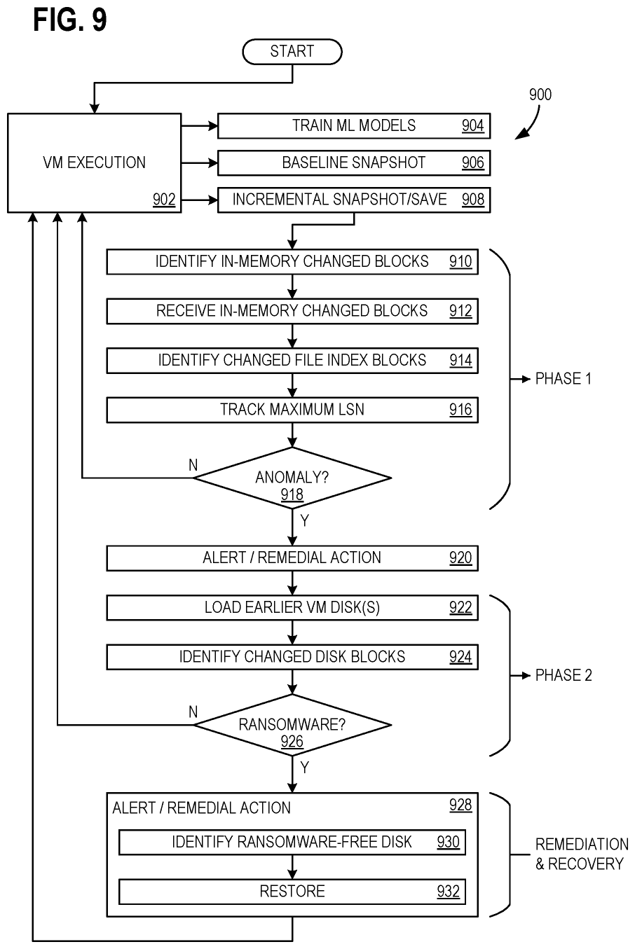

FIG. 9 illustrates a flowchart 900 of exemplary operations associated with architecture 100. In some examples, the operations of flowchart 900 are performed by one or more computing apparatus 1318 of FIG. 13. Flowchart 900 commences by starting execution of VM 110 in operation 902. When time series 318 is available, it is used to train ML models 302 and 304 in operation 904. ML model 302 is trained to detect anomalous conditions, and ML model 304 is trained to determine whether changes in blocks indicate ransomware, using time-series 318.

In some examples, certain time-based behavior within the normal activity for VM 110 becomes apparent, such as increased activity and file changed during typical business hours and on a periodic basis, such correlated with a software update schedule. This enables ML models 302 and 304 to be able to more readily when activity not fitting within the normal timing is suspicious, such as changes to a larger number of files than is typical, and occurring outside typical days or business hours.

A baseline snapshot is saved in operation 906, and operation 908 saves incremental snapshots (e.g., as a file back-up) or otherwise performs an incremental file save of VM disk 130 (e.g., a VM disk image). Operation 908 may recur on a schedule, such as hourly, or on a milestone event, and triggers the detection of in-memory changed data blocks 142 in operation 910 (e.g., by snapshot manager 140).

In operation 912, anomaly detector 152 receives in-memory changed data blocks 142 from data stream 148 (e.g., by intercepting an incremental file save data stream). This is rapid, because in-memory changed data blocks 142 are pulled from live memory, rather than being read from persistent storage 112. Operation 914 identifies changed file index blocks 144 within in-memory changed data blocks 142. Changed file index blocks 144 are a (non-empty) subset of in-memory changed data blocks 142 that are addressed for storage within file index 400 for VM disk 130. In some examples, changed file index blocks 144 are identified using LBAs of in-memory changed data blocks 142 that indicate a position early enough within VM disk 130 to be within file index 400 (specifically, within file table 430).

Operation 916 tracks a maximum LSN of file index 400, to enable ascertaining whether a changed block within file index 400 indicates a new changed file (by a larger new LSN), or a deleted file (identified by an “in-use” flag in file index 400). In some examples, anomaly detector 152 performs both operations 912 and 914.

In decision operation 918, anomaly detector 152 determines whether an anomalous condition exists, for example a change history of file index 400 (e.g., from time series 318). In some examples, ransomware indications include one or more of: a count of in-memory changed blocks, timing of in-memory changed blocks, a file extension correlated with ransomware, and entropy of file names. Other possible indications include a count of directories having an additional files, deleted files, and/or changed files (e.g., reflected in timestamps). In some examples, decision operation 918 uses at least a portion of flowchart 600 of FIG. 6.

If no anomalous condition exists, flowchart 900 returns to VM execution in operation 902. Operations 910-918 are a first phase of the multi-phased approach. If an anomalous condition is detected, anomaly detector 152 generates alert 156 and controller 160 responds in operation 920 by performing a remedial action (remediation activity) such as suspending back-up file (e.g., snapshot) expirations, storing a copy of live memory 120 (e.g., the memory of VM 110), tagging VM 110 as suspected of containing ransomware, and/or storing the state of VM 110. In some examples, controller 160 also transmits message 172 across computer network 170 to monitoring node 174.

Flowchart 900 then moves to the second phase, which includes operations 922-926, based on at least determining the anomalous condition. In operation 922, disk comparator 154 loads at least a portion of a prior-saved version of VM disk 130 (e.g., VM disk 130c) from persistent storage 112 so that two versions of VM disk 130, taken at different times, may be compared.

Operation 924 identifies set of blocks 506 and, within it, changed blocks 502 within file index 400 that are changed between the two versions of VM disk 130. In decision operation 926, disk comparator 154 determines whether changes in set of blocks 506 indicate ransomware. This may use indications such as entropy within set of blocks 506, an added file extension is correlated with ransomware, a high count of directories having an additional file, and a count of changed files. High file name entropy within changed blocks 502 indicates machine-generated file names, while high entropy within changed blocks 504 indicate encrypted file contents. Some examples identify deleted files by comparing sequence numbers (e.g., MFT sequence numbers) with a sequence numbers from a prior snapshot. In some examples, decision operation 926 uses at least a portion of flowchart 700 of FIG. 7.

If there is no ransomware, flowchart 900 returns to VM execution in operation 902. Otherwise, if ransomware 126 is detected, flowchart 900 then moves to remediation and recovery in operation 928. Disk comparator 154 generates alert 158 and controller 160 responds in operation 928 by performing a remedial action such as suspending back-up file expirations, storing a copy of live memory 120, tagging VM as being infected with ransomware, storing the state of VM 110, and sandboxing VM 110 to prevent ransomware 126 from spreading to other VMs. In some examples, controller 160 also transmits message 172 across computer network 170 to monitoring node 174.

In some examples, restoration logic 164 identifies a prior snapshot (e.g., the most recent one of VM disk 130a-103c) that is free of ransomware 126, so that it does not have encrypted files, in operation 930. Restoration logic 164 then restores VM disk 130 from that clean prior snapshot in operation 932. In some examples, a prior snapshot, from early in the attack, that has a minimum number of encrypted files, may also be used to restore recent files that had not yet been encrypted. Flowchart 900 returns to VM execution in operation 902 to continue protecting against ransomware.

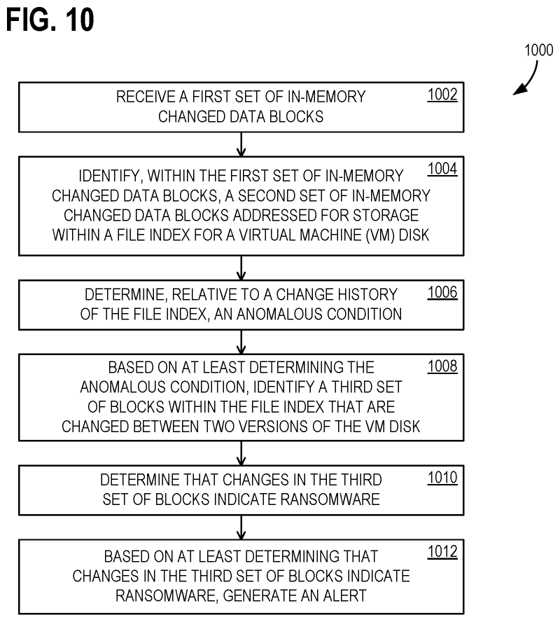

FIG. 10 illustrates a flowchart 1000 of exemplary operations associated with architecture 100. In some examples, the operations of flowchart 1000 are performed by one or more computing apparatus 1318 of FIG. 13. Flowchart 1000 commences with operation 1002, which includes receiving a first set of in-memory changed data blocks. Operation 1004 includes identifying, within the first set of in-memory changed data blocks, a second set of in-memory changed data blocks addressed for storage within a file index for a VM disk.

Operation 1006 includes determining, relative to a change history of the file index, an anomalous condition. Operation 1008 includes, based on at least determining the anomalous condition, identifying a third set of blocks within the file index that are changed between two versions of the VM disk. Operation 1010 includes determining that changes in the third set of blocks indicate ransomware. Operation 1012 includes, based on at least determining that changes in the third set of blocks indicate ransomware, generating an alert.

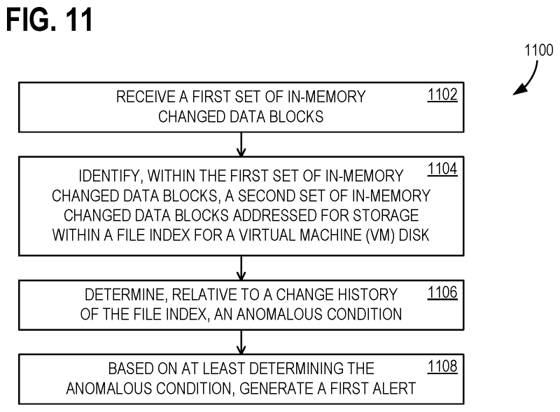

FIG. 11 illustrates a flowchart 1100 of exemplary operations associated with architecture 100. In some examples, the operations of flowchart 1100 are performed by one or more computing apparatus 1318 of FIG. 13. Flowchart 1100 commences with operation 1102, which includes receiving a first set of in-memory changed data blocks. Operation 1104 includes identifying, within the first set of in-memory changed data blocks, a second set of in-memory changed data blocks addressed for storage within a file index for a VM disk. Operation 1106 includes determining, relative to a change history of the file index, an anomalous condition. Operation 1108 includes, based on at least determining the anomalous condition, generating a first alert.

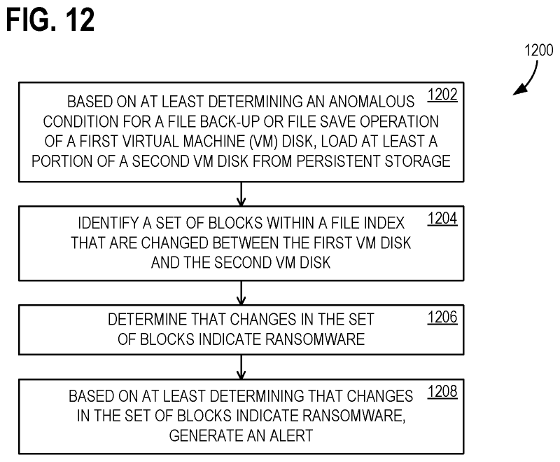

FIG. 12 illustrates a flowchart 1200 of exemplary operations associated with architecture 100. In some examples, the operations of flowchart 1200 are performed by one or more computing apparatus 1318 of FIG. 13. Flowchart 1200 commences with operation 1202, which includes based on at least determining an anomalous condition for a file back-up operation or file save operation of a first VM disk, loading at least a portion of a second VM disk from persistent storage.

Operation 1204 includes identifying a set of blocks within a file index that are changed between the first VM disk and the second VM disk. Operation 1206 includes determining that changes in the set of blocks indicate ransomware. Operation 1208 includes, based on at least determining that changes in the set of blocks indicate ransomware, generating an alert.

### ADDITIONAL EXAMPLES

An example method of rapid ransomware detection comprises: receiving a first set of in-memory changed data blocks; identifying, within the first set of in-memory changed data blocks, a second set of in-memory changed data blocks addressed for storage within a file index for a VM disk; determining, relative to a change history of the file index, an anomalous condition; based on at least determining the anomalous condition, identifying a third set of blocks within the file index that are changed between two versions of the VM disk; determining that changes in the third set of blocks indicate ransomware; and based on at least determining that changes in the third set of blocks indicate ransomware, generating an alert.

Another example method of rapid ransomware detection comprises: receiving a first set of in-memory changed data blocks; identifying, within the first set of in-memory changed data blocks, a second set of in-memory changed data blocks addressed for storage within a file index for a VM disk; determining, relative to a change history of the file index, an anomalous condition; and based on at least determining the anomalous condition, generating a first alert.

Another example method of rapid ransomware detection comprises: based on at least determining an anomalous condition for a file back-up operation or file save operation of a first VM disk, loading at least a portion of a second VM disk from persistent storage; identifying a set of blocks within a file index that are changed between the first VM disk and the second VM disk; determining that changes in the set of blocks indicate ransomware; and based on at least determining that changes in the set of blocks indicate ransomware, generating an alert.

An example computer system for rapid ransomware detection comprises: a processor; and a non-transitory computer readable medium having stored thereon program code executable by the processor, the program code causing the processor to: receive a first set of in-memory changed data blocks; identify, within the first set of in-memory changed data blocks, a second set of in-memory changed data blocks addressed for storage within a file index for a VM disk; determine, relative to a change history of the file index, an anomalous condition; based on at least determining the anomalous condition, identify a third set of blocks within the file index that are changed between two versions of the VM disk; determine that changes in the third set of blocks indicate ransomware; and based on at least determining that changes in the third set of blocks indicate ransomware, generate an alert.

Another example computer system for rapid ransomware detection comprises: a processor; and a non-transitory computer readable medium having stored thereon program code executable by the processor, the program code causing the processor to: receive a first set of in-memory changed data blocks; identify, within the first set of in-memory changed data blocks, a second set of in-memory changed data blocks addressed for storage within a file index for a VM disk; determine, relative to a change history of the file index, an anomalous condition; and based on at least determining the anomalous condition, generate a first alert.

Another example computer system for rapid ransomware detection comprises: a processor; and a non-transitory computer readable medium having stored thereon program code executable by the processor, the program code causing the processor to: based on at least determining an anomalous condition for a file back-up operation or file save operation of a first VM disk, load at least a portion of a second VM disk from persistent storage; identify a set of blocks within a file index that are changed between the first VM disk and the second VM disk; determine that changes in the set of blocks indicate ransomware; and based on at least determining that changes in the set of blocks indicate ransomware, generate an alert.

An example non-transitory computer storage medium has stored thereon program code executable by a processor, the program code embodying a method comprising: receiving a first set of in-memory changed data blocks; identifying, within the first set of in-memory changed data blocks, a second set of in-memory changed data blocks addressed for storage within a file index for a VM disk; determining, relative to a change history of the file index, an anomalous condition; based on at least determining the anomalous condition, identifying a third set of blocks within the file index that are changed between two versions of the VM disk; determining that changes in the third set of blocks indicate ransomware; and based on at least determining that changes in the third set of blocks indicate ransomware, generating an alert.

Another example non-transitory computer storage medium has stored thereon program code executable by a processor, the program code embodying a method comprising: receiving a first set of in-memory changed data blocks; identifying, within the first set of in-memory changed data blocks, a second set of in-memory changed data blocks addressed for storage within a file index for a VM disk; determining, relative to a change history of the file index, an anomalous condition; and based on at least determining the anomalous condition, generating a first alert.

Another example non-transitory computer storage medium has stored thereon program code executable by a processor, the program code embodying a method comprising: based on at least determining an anomalous condition for a file back-up operation or file save operation of a first VM disk, loading at least a portion of a second VM disk from persistent storage; identifying a set of blocks within a file index that are changed between the first VM disk and the second VM disk; determining that changes in the set of blocks indicate ransomware; and based on at least determining that changes in the set of blocks indicate ransomware, generating an alert.

Alternatively, or in addition to the other examples described herein, examples include any combination of the following:
based on at least determining the anomalous condition, performing a first remedial action selected from the group consisting of: suspending back-up file expirations, storing a copy of a VM memory, tagging a VM, and storing a VM state;
based on at least determining that the third set of blocks indicate ransomware, transmitting a message across a computer network to a monitoring node;
based on at least determining that the third set of blocks indicate ransomware, performing a second remedial action selected from the group consisting of: suspending back-up file expirations, storing a copy of a VM memory, tagging a VM, storing a VM state, sandboxing the VM, and restoring the VM disk from a prior snapshot;
receiving the set of in-memory changed data blocks comprises intercepting an incremental back-up data stream;
receiving the set of in-memory changed data blocks comprises intercepting an incremental file save data stream;
the in-memory changed data blocks have not been read from a persistent storage;
the file index comprises a set of file records for files in the VM disk;
each file in the VM disk has a corresponding file record;
determining the anomalous condition comprises determining at least one ransomware indication selected from the group consisting of: a count of in-memory changed blocks, timing of in-memory changed blocks, a file extension correlated with ransomware, and entropy of file names;
determining that changes in the third set of blocks indicate ransomware comprises determining at least one ransomware indication selected from the group consisting of: entropy within the third set of blocks, an added file extension is correlated with ransomware, a count of directories having an additional file, and a count of changed files;
identifying encrypted files comprises mapping data blocks having high entropy to files using the file index;
identify deleted files comprises comparing an MFT sequence number with an MFT sequence number from a prior snapshot;
a first ML model determines the anomalous condition;
a second ML model determines whether changes in the third set of blocks indicate ransomware;
based on at least determining the anomalous condition, identifying a third set of blocks within the file index that are changed between two versions of the VM disk;
determining that changes in the third set of blocks indicate ransomware;
based on at least determining that changes in the third set of blocks indicate ransomware, generating a second alert;
receiving a first set of in-memory changed data blocks for the first VM disk;
identifying, within the first set of in-memory changed data blocks, a second set of in-memory changed data blocks addressed for storage within the file index;
determining, relative to a change history of the file index, the anomalous condition;
the file back-up operation comprises an incremental back-up operation;
the file save operation comprises an incremental file save operation;
training the first ML model to detect anomalous conditions using a time series of file indexes;
training the first ML model to detect anomalous conditions using a plurality of time series of file indexes from a plurality of separately controlled virtualized environments;
training the second ML model to determine whether changes in blocks indicate ransomware using a time series of file indexes;
training the second ML model to determine whether changes in blocks indicate ransomware using a plurality of time series of file indexes from a plurality of separately controlled virtualized environments;
triggering the detection of the first set of in-memory changed data blocks on a file save operation or a file back-up operation;
the file back-up operation comprises performing a snapshot of a virtual machine disk image;
detecting the first set of in-memory changed data blocks;
the in-memory changed data blocks comprise streaming data;
the in-memory changed data blocks each have a size of 4 KB;
identifying the second set of in-memory changed data blocks comprises determining LBAs of in-memory changed data blocks;
tracking a maximum LSN of the file index;
the file index comprises an MFT formatted for NTFS;
the MFT comprises a set of MFT records for files in the VM disk;
each file in the VM disk has a corresponding MFT record;
determining whether an anomalous condition exists;
determining the anomalous condition comprises determining a count of directories having an additional file and/or changed files;
determining whether a file index change indicates a changed file comprises comparing a LSN within the file index with a maximum LSN of a prior back-up file;
determining whether a file has changed by comparing a current timestamp for the file with a timestamp for the file in a prior snapshot;
based on at least determining the anomalous condition, transmitting a message across a computer network to a monitoring node;
the two versions of the VM disk comprise snapshots of the VM disk taken at different times;
determining whether changes in the third set of blocks indicate ransomware;
generating the second alert comprises transmitting a message across a computer network to a monitoring node;
identifying a prior snapshot that is free of ransomware; and
the prior snapshot is free of ransomware.

### Exemplary Operating Environment

The present disclosure is operable with a computing device (computing apparatus) according to an embodiment shown as a functional block diagram 1300 in FIG. 13. In an embodiment, components of a computing apparatus 1318 may be implemented as part of an electronic device according to one or more embodiments described in this specification. The computing apparatus 1318 comprises one or more processors 1319 which may be microprocessors, controllers, or any other suitable type of processors for processing computer executable instructions to control the operation of the electronic device. Alternatively, or in addition, the processor 1319 is any technology capable of executing logic or instructions, such as a hardcoded machine. Platform software comprising an operating system 1320 or any other suitable platform software may be provided on the computing apparatus 1318 to enable application software 1321 to be executed on the device. According to an embodiment, the operations described herein may be accomplished by software, hardware, and/or firmware.

Computer executable instructions may be provided using any computer-readable medium (e.g., any non-transitory computer storage medium) or media that are accessible by the computing apparatus 1318. Computer-readable media may include, for example, computer storage media such as a memory 1322 and communications media. Computer storage media, such as a memory 1322, include volatile and non-volatile, removable, and non-removable media implemented in any method or technology for storage of information such as computer readable instructions, data structures, program modules or the like. Computer storage media include, but are not limited to, hard disks, RAM, ROM, EPROM, EEPROM, NVMe devices, persistent memory, phase change memory, flash memory or other memory technology, compact disc (CD, CD-ROM), digital versatile disks (DVD) or other optical storage, magnetic cassettes, magnetic tape, magnetic disk storage, shingled disk storage or other magnetic storage devices, or any other non-transmission medium (e., non-transitory) that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 1322) is shown within the computing apparatus 1318, it will be appreciated by a person skilled in the art, that the storage may be distributed or located remotely and accessed via a network or other communication link (e.g. using a communication interface 1323). Computer storage media are tangible, non-transitory, and are mutually exclusive to communication media.

The computing apparatus 1318 may comprise an input/output controller 1324 configured to output information to one or more output devices 1325, for example a display or a speaker, which may be separate from or integral to the electronic device. The input/output controller 1324 may also be configured to receive and process an input from one or more input devices 1326, for example, a keyboard, a microphone, or a touchpad. In one embodiment, the output device 1325 may also act as the input device. An example of such a device may be a touch sensitive display. The input/output controller 1324 may also output data to devices other than the output device, e.g. a locally connected printing device. In some embodiments, a user may provide input to the input device(s) 1326 and/or receive output from the output device(s) 1325.

The functionality described herein can be performed, at least in part, by one or more hardware logic components. According to an embodiment, the computing apparatus 1318 is configured by the program code when executed by the processor 1319 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

Although described in connection with an exemplary computing system environment, examples of the disclosure are operative with numerous other general purpose or special purpose computing system environments or configurations. Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices.

Examples of the disclosure may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

Aspects of the disclosure transform a general-purpose computer into a special purpose computing device when programmed to execute the instructions described herein. The detailed description provided above in connection with the appended drawings is intended as a description of a number of embodiments and is not intended to represent the only forms in which the embodiments may be constructed, implemented, or utilized. Although these embodiments may be described and illustrated herein as being implemented in devices such as a server, computing devices, or the like, this is only an exemplary implementation and not a limitation. As those skilled in the art will appreciate, the present embodiments are suitable for application in a variety of different types of computing devices, for example, PCs, servers, laptop computers, tablet computers, etc.

The term “computing device” and the like are used herein to refer to any device with processing capability such that it can execute instructions. Those skilled in the art will realize that such processing capabilities are incorporated into many different devices and therefore the terms “computer”, “server”, and “computing device” each may include PCs, servers, laptop computers, mobile telephones (including smart phones), tablet computers, and many other devices. Any range or device value given herein may be extended or altered without losing the effect sought, as will be apparent to the skilled person. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

While no personally identifiable information is tracked by aspects of the disclosure, examples may have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” and “the” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A computerized method of ransomware detection, the method comprising:
receiving a first set of in-memory changed data blocks;
identifying, within the first set of in-memory changed data blocks, a second set of in-memory changed data blocks addressed for storage within a file index for a virtual machine (VM) disk;
determining, relative to a change history of the file index, an anomalous condition; and
based on at least determining the anomalous condition, generating a first alert.

2. The method of claim 1, further comprising:
based on at least determining the anomalous condition, performing a first remedial action selected from the group consisting of: suspending back-up file expirations, storing a copy of a VM memory, tagging a VM, and storing a VM state.

3. The method of claim 1, further comprising:
based on at least determining the anomalous condition, identifying a third set of blocks within the file index that are changed between two versions of the VM disk;
determining that changes in the third set of blocks indicate ransomware; and
based on at least determining that changes in the third set of blocks indicate ransomware, generating a second alert.

4. The method of claim 1, wherein
receiving the set of in-memory changed data blocks comprises intercepting an incremental back-up data stream; or
receiving the set of in-memory changed data blocks comprises intercepting an incremental file save data stream, wherein the in-memory changed data blocks have not been read from a persistent storage.

5. The method of claim 1, wherein the file index comprises a set of file records for files in the VM disk, and wherein each file in the VM disk has a corresponding file record.

6. The method of claim 1, wherein determining the anomalous condition comprises determining at least one ransomware indication selected from the group consisting of: a count of in-memory changed blocks, timing of in-memory changed blocks, a file extension correlated with ransomware, and entropy of file names.

7. The method of claim 1, wherein a machine learning (ML) model determines the anomalous condition.

8. A computer system for ransomware detection, the system comprising:
a processor; and
a non-transitory computer readable medium having stored thereon program code executable by the processor, the program code causing the processor to:
receive a first set of in-memory changed data blocks;
identify, within the first set of in-memory changed data blocks, a second set of in-memory changed data blocks addressed for storage within a file index for a virtual machine (VM) disk;
determine, relative to a change history of the file index, an anomalous condition; and
based on at least determining the anomalous condition, generate a first alert.

9. The computer system of claim 8, wherein the program code is further operative to:
based on at least determining the anomalous condition, perform a first remedial action selected from the group consisting of: suspending back-up file expirations, storing a copy of a VM memory, tagging a VM, and storing a VM state.

10. The computer system of claim 8, wherein the program code is further operative to:
based on at least determining the anomalous condition, identify a third set of blocks within the file index that are changed between two versions of the VM disk;
determine that changes in the third set of blocks indicate ransomware; and
based on at least determining that changes in the third set of blocks indicate ransomware, generate a second alert.

11. The computer system of claim 8, wherein
receiving the set of in-memory changed data blocks comprises intercepting an incremental back-up data stream; or
receiving the set of in-memory changed data blocks comprises intercepting an incremental file save data stream, wherein the in-memory changed data blocks have not been read from a persistent storage.

12. The computer system of claim 8, wherein the file index comprises a set of file records for files in the VM disk, and wherein each file in the VM disk has a corresponding file record.

13. The computer system of claim 8, wherein determining the anomalous condition comprises determining at least one ransomware indication selected from the group consisting of: a count of in-memory changed blocks, timing of in-memory changed blocks, a file extension correlated with ransomware, and entropy of file names.

14. The computer system of claim 8, wherein a machine learning (ML) model determines the anomalous condition.

15. A non-transitory computer storage medium having stored thereon program code executable by a processor, the program code embodying a method comprising:
receiving a first set of in-memory changed data blocks;
identifying, within the first set of in-memory changed data blocks, a second set of in-memory changed data blocks addressed for storage within a file index for a virtual machine (VM) disk;
determining, relative to a change history of the file index, an anomalous condition; and
based on at least determining the anomalous condition, generating a first alert.

16. The computer storage medium of claim 15, wherein the program code method further comprises:
based on at least determining the anomalous condition, performing a first remedial action selected from the group consisting of: suspending back-up file expirations, storing a copy of a VM memory, tagging a VM, and storing a VM state.

17. The computer storage medium of claim 15, wherein the program code method further comprises:
based on at least determining the anomalous condition, identifying a third set of blocks within the file index that are changed between two versions of the VM disk;
determining that changes in the third set of blocks indicate ransomware; and
based on at least determining that changes in the third set of blocks indicate ransomware, generating a second alert.

18. The computer storage medium of claim 15, wherein
receiving the set of in-memory changed data blocks comprises intercepting an incremental back-up data stream; or
receiving the set of in-memory changed data blocks comprises intercepting an incremental file save data stream, wherein the in-memory changed data blocks have not been read from a persistent storage.

19. The computer storage medium of claim 15, wherein the file index comprises a set of file records for files in the VM disk, and wherein each file in the VM disk has a corresponding file record.

20. The computer storage medium of claim 15, wherein determining the anomalous condition comprises determining at least one ransomware indication selected from the group consisting of: a count of in-memory changed blocks, timing of in-memory changed blocks, a file extension correlated with ransomware, and entropy of file names.
